(19) United States
(12) Patent Application Publication
(10) Pub. No.: US 2026/0085738 A1
(43) Pub. Date: Mar. 26, 2026

(54) ANTI-VIBRATION BUSH

(71) Applicant: SUBARU CORPORATION, Tokyo (JP)

(72) Inventors: Satoru AKIYAMA, Tokyo (JP); Koichi UCHIKAWA, Tokyo (JP); Qiaoqin ZHOU, Tokyo (JP)

(73) Assignee: SUBARU CORPORATION, Tokyo (JP)

(21) Appl. No.: 19/293,709

(22) Filed: Aug. 7, 2025

(30) Foreign Application Priority Data
Sep. 24, 2024 (JP) 2024-164436

(51) Int. Cl. F16F 1/38

(52) U.S. Cl. CPC F16F 1/3807; B60G 2204/41; F16F 2228/08; F16F 2234/02

(57) ABSTRACT

An anti-vibration bush includes an outer cylinder, an inner cylinder, an elastic body, a bulging cylinder, a tightening member, and a spacer. The inner cylinder is inside the outer cylinder. The elastic body fills a space between the outer and inner cylinders. The bulging cylinder is at an intermediate part of the inner cylinder in a central axis direction and bulges radially outward relative to the inner cylinder. The tightening member applies a compressive force in the central axis direction to ends of the inner cylinder during tightening. The spacer is between the inner cylinder and the tightening member along the central axis direction of the inner cylinder. The spacer regulates the compressive force when the tightening member is brought into contact with ends of the spacer. The bulging cylinder undergoes radially outward deformation in response to a deformation amount corresponding to the compressive force, thus pressing the elastic body.

### CROSS-REFERENCE TO RELATED APPLICATIONS

The present application claims priority from Japanese Patent Application No. 2024-164436 filed on Sep. 20, 2024, the entire contents of which are hereby incorporated by reference.

### BACKGROUND

The disclosure relates to an anti-vibration bush including an outer cylinder, an inner cylinder, and an elastic body, such as rubber, coupling the outer cylinder and the inner cylinder.

Anti-vibration bushes are commonly used for coupling arms and the like in, for example, a suspension apparatus of a vehicle. The anti-vibration characteristics (stiffness) of such anti-vibration bushes are to be individually adjusted in accordance with loads input to coupling parts.

As techniques for adjusting the characteristics of the anti-vibration bushes, for example, a technique disclosed in Japanese Unexamined Patent Application Publication (JP-A) No. 2022-18166 is known. The technique disclosed in JP-A No. 2022-18166 is a technique in which an anti-vibration bush is divided, along its central axis, into an intermediate bush and end bushes. With the technique of JP-A No. 2022-18166, it is possible to prepare in advance multiple types of end bushes different from each other in dimension, composition, and the like, and to assemble the anti-vibration bush through selecting of optimum end bushes in response to receiving the determination of the anti-vibration performance.

### SUMMARY

An aspect of the disclosure provides an anti-vibration bush. The anti-vibration bush includes an outer cylinder, an inner cylinder, an elastic body, a bulging cylinder, a tightening member, and a spacer. The inner cylinder is provided inside the outer cylinder. The elastic body is provided so as to fill a space between the outer cylinder and the inner cylinder. The bulging cylinder is provided at an intermediate part of the inner cylinder in a central axis direction and has a shape bulging radially outward relative to the inner cylinder. The tightening member is configured to tighten the inner cylinder and a bracket and apply a compressive force in the central axis direction to the inner cylinder at both ends of the inner cylinder during tightening the inner cylinder and the bracket. The spacer is configured to be inserted between the inner cylinder and the tightening member along the central axis direction of the inner cylinder. The spacer has a length shorter than a length of the inner cylinder in the central axis direction, and is configured to regulate the compressive force when the tightening member is brought into contact with both ends of the spacer. The bulging cylinder is configured to undergo radially outward deformation in response to a deformation amount corresponding to the compressive force applied to the inner cylinder, and thus press the elastic body.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a rear view of a suspension apparatus according to an embodiment of the disclosure;

FIG. 2 is a perspective view illustrating a coupling part between a lower arm and a bracket;

FIG. 3 is an exploded perspective view of the anti-vibration bush;

FIG. 4 is a cross-sectional view taken along line IV-IV of FIG. 1;

FIG. 5 is a cross-sectional view illustrating an anti-vibration bush immediately before a compressive force is applied;

FIG. 6 is a perspective view illustrating an inner cylinder;

FIG. 7 is an exploded perspective view illustrating a lower arm and a bush body;

FIG. 8 is a cross-sectional view illustrating an anti-vibration bush using a spacer having a length different from that in FIG. 4;

FIG. 9 is a perspective view illustrating an inner cylinder according to a modification example;

FIG. 10 is a cross-sectional view illustrating an anti-vibration bush according to the modification example;

FIG. 11 is a cross-sectional view illustrating the anti-vibration bush before tightening torque is applied according to the modification example; and

FIG. 12 is a cross-sectional view illustrating an anti-vibration bush using a spacer having a length different from that in FIG. 10 according to the modification example.

### DETAILED DESCRIPTION

In the technique of JP-A No. 2022-18166 described above, multiple types of end bushes are to be prepared in advance in order to adjust the anti-vibration characteristics. Thus, the technique of JP-A No. 2022-18166 may have difficulty in efficiently adjusting the anti-vibration characteristics.

It is desirable to provide an anti-vibration bush capable of efficiently adjusting anti-vibration characteristics.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

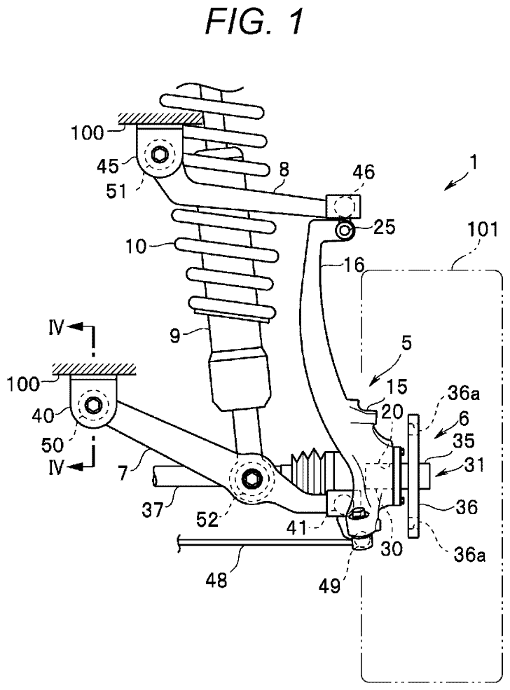

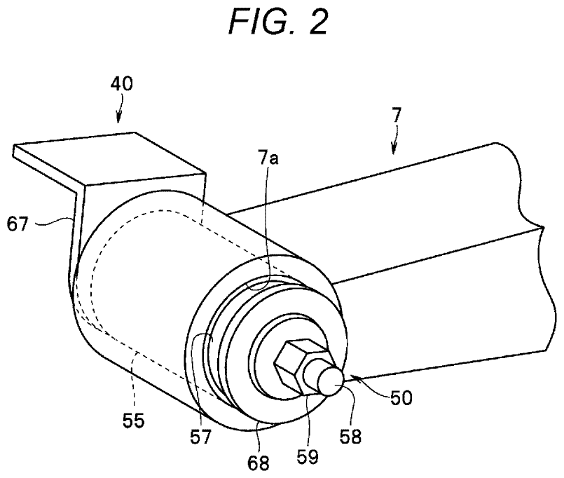

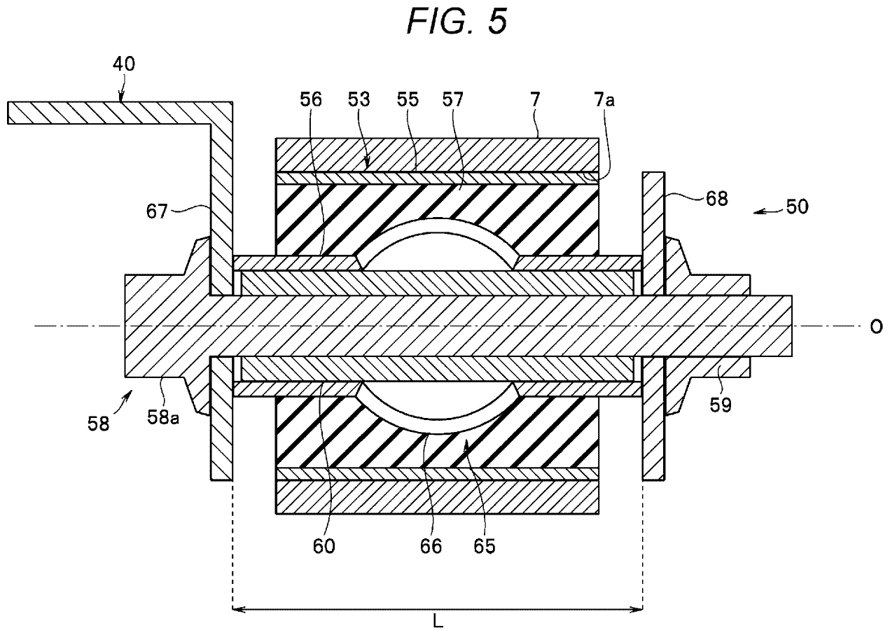

FIGS. 1 to 8 relate to an embodiment of the disclosure, and FIG. 1 is a rear view of a suspension apparatus.

A suspension apparatus 1 illustrated in FIG. 1 is a high-mount double wishbone suspension apparatus.

As illustrated in FIG. 1, the suspension apparatus 1 includes a housing (knuckle) 5, a wheel hub unit 6, a lower arm 7, an upper arm 8, a hydraulic damper 9, and a suspension spring 10.

The housing 5 includes a housing body 15 and a coupling arm 16.

The housing body 15 has a bearing insertion hole 20. The housing body 15 further has a first ball joint mounting hole and a second ball joint mounting hole (both not illustrated).

The bearing insertion hole 20 is a cylindrical hole penetrating the housing body 15 in a vehicle width direction.

The first ball joint mounting hole is a hole, at a lower end of the housing body 15, penetrating the housing body 15 in an up-down direction.

The second ball joint mounting hole is provided in, for example, a protrusion 23 protruding rearward from a lower part of the housing body 15. The second ball joint mounting hole is a hole penetrating the protrusion 23 in the up-down direction.

The coupling arm 16 extends from an upper part of the housing body 15 to reach a position higher than a tire 101. The coupling arm 16 has, at its distal end, a mounting hole 25.

The wheel hub unit 6 includes a bearing 30 and a wheel hub 31.

The bearing 30 is fixed to the housing body 15 in a state of being placed through the bearing insertion hole 20.

The wheel hub 31 is rotatably supported by the housing body 15 via the bearing 30. The wheel hub 31 includes a shaft support cylinder 35 and a flange 36.

The shaft support cylinder 35 has a substantially cylindrical shape. The shaft support cylinder 35 is spline-coupled to a distal end of a drive shaft 37, which is an axle. Consequently, the distal end of the drive shaft 37 is rotatably supported by the housing body 15 via the wheel hub unit 6.

The flange 36 is provided on the outer periphery of the shaft support cylinder 35. The flange 36 has bolt insertion holes 36a for coupling a brake disc and the wheel of the tire 101 by tightening.

A proximal end of the lower arm 7 is swingably supported with respect to a vehicle body 100 via a bracket 40. A distal end of the lower arm 7 is coupled to the first ball joint mounting hole via a ball joint 41.

A proximal end of the upper arm 8 is swingably supported with respect to the vehicle body 100 via a bracket 45. A distal end of the upper arm 8 is coupled to the mounting hole 25 of the coupling arm 16 via a ball joint 46.

An upper end of the hydraulic damper 9 is coupled to the vehicle body 100 via a strut mount (not illustrated). A lower end of the hydraulic damper 9 is coupled to an intermediate part of the lower arm 7. The suspension spring 10 is held on the outer periphery of the hydraulic damper 9.

A tie rod 48 extending from a steering mechanism (not illustrated) is coupled to the second ball joint mounting hole of the housing body 15 via a ball joint 49.

In such a suspension apparatus 1, for example, the lower arm 7 and the bracket 40 are coupled via an anti-vibration bush 50. The upper arm 8 and the bracket 45 are coupled via an anti-vibration bush 51. The hydraulic damper 9 and the lower arm 7 are coupled via an anti-vibration bush 52.

Hereinafter, the coupling structure between the lower arm 7 and the bracket 40 will be described in detail. The coupling structure between the upper arm 8 and the bracket 45 and the coupling structure between the hydraulic damper 9 and the lower arm 7 are substantially similar to the coupling structure between the lower arm 7 and the bracket 40, and thus a detailed description thereof will be omitted.

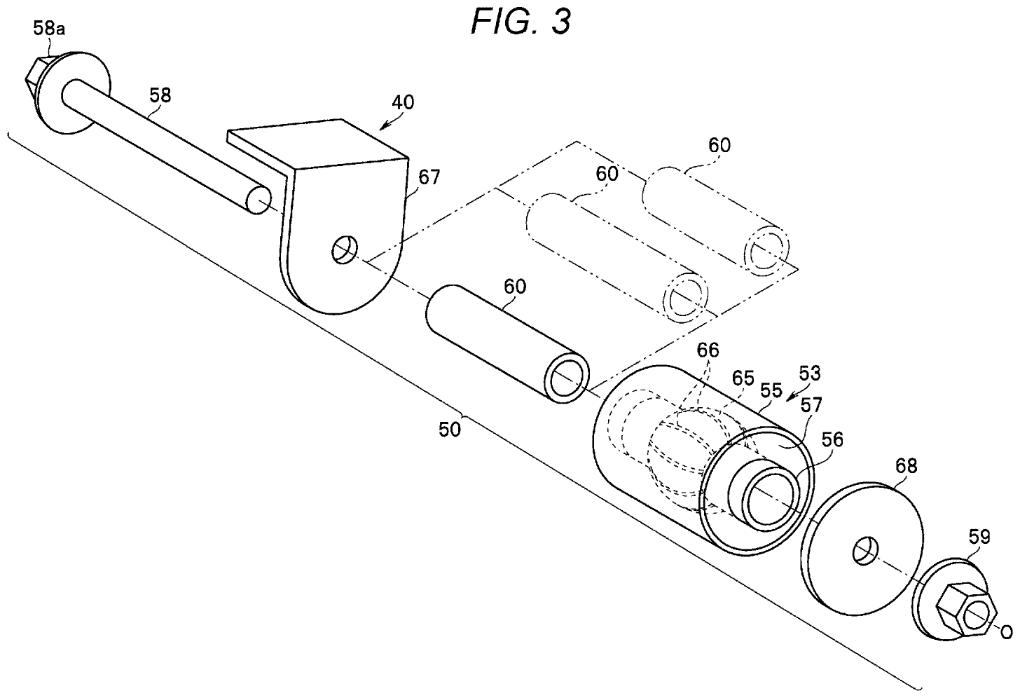

As illustrated in FIGS. 3 to 5, the anti-vibration bush 50 includes an outer cylinder 55, an inner cylinder 56, rubber 57 as an elastic body, a bolt 58 and a nut 59 as tightening members, and a spacer 60.

The outer cylinder 55 has, for example, a cylindrical shape. For example, as illustrated in FIG. 7, the outer cylinder 55 can be held by the proximal end of the lower arm 7. In one example, the proximal end of the lower arm 7 has a bush holding hole 7a. The outer diameter of the outer cylinder 55 is set to be slightly larger than the inner diameter of the bush holding hole 7a. Consequently, the outer cylinder 55 can be inserted into the bush holding hole 7a by press-fitting. The outer cylinder 55 press-fitted into the bush holding hole 7a is held by the proximal end of the lower arm 7.

The inner cylinder 56 has an outer diameter sufficiently smaller than the inner diameter of the outer cylinder 55. For example, a central axis O of the inner cylinder 56 is disposed coaxially with a central axis O of the outer cylinder 55.

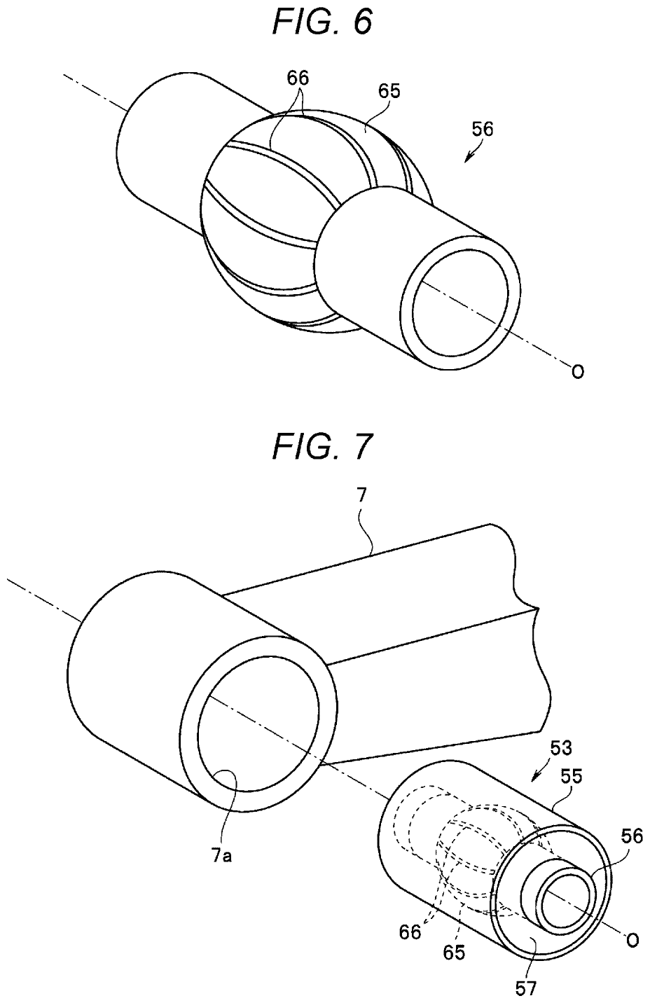

As illustrated in FIG. 6, the inner cylinder 56 has a bulging cylinder 65 at an intermediate part thereof in a central axis O direction. The bulging cylinder 65 is permanently affixed with the inner cylinder 56. The bulging cylinder 65 has a shape bulging radially outward relative to the inner cylinder 56. In the present embodiment, the bulging cylinder 65 has a hollow partially spherical shape. The bulging cylinder 65 has slits 66 extending in the central axis O direction of the inner cylinder 56. For example, the slits 66 are provided at equal intervals around the central axis O of the inner cylinder 56. The slits 66 serve as deformation promoting parts for promoting outer-diameter-directional elastic deformation of the bulging cylinder 65 when a compressive force in the central axis O direction is applied to both ends of the inner cylinder 56.

The rubber 57 is provided so as to fill a space between the outer cylinder 55 and the inner cylinder 56. Consequently, the outer cylinder 55, the inner cylinder 56, and the rubber 57 are permanently coupled to constitute a bush body 53.

The rubber 57, upon application of a pressing force, undergoes a change in reference elastic properties (stiffness). That is, for example, the rubber 57, when pressed from the inside due to the deformation of the bulging cylinder 65, increases its reference stiffness. In one example, the stiffness of the rubber 57 increases as the pressing amount due to the deformation of the bulging cylinder 65 increases.

For example, the bolt 58 is placed through the inner cylinder 56 from a side of a first end of the inner cylinder 56 in the central axis O direction. On a side of a second end of the inner cylinder 56, the nut 59 is screwed to the bolt 58. The bolt 58 and the nut 59 can compress the ends of the inner cylinder 56 by tightening. With this tightening, the bolt 58 and the nut 59 apply a compressive force in the central axis O direction to the inner cylinder 56. This compressive force changes in accordance with the tightening amount of the bolt 58 and the nut 59.

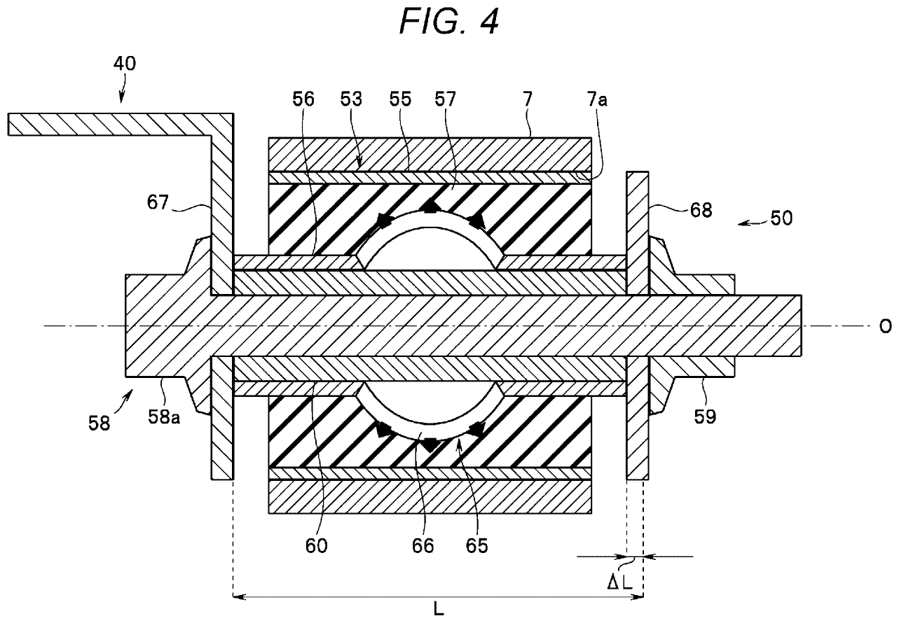

Here, as illustrated in FIG. 4, the bolt 58 and the nut 59 apply a compressive force to the inner cylinder 56 via a first abutment plate 67 and a second abutment plate 68 respectively disposed at the ends of the inner cylinder 56. In the present embodiment, the first abutment plate 67 is permanently affixed with the bracket 40. Consequently, the bracket 40 is coupled to the inner cylinder 56 (bush body 53) by tightening together with the bolt 58 and the nut 59.

The spacer 60 is provided between the inner cylinder 56 and the bolt 58 along the central axis O direction of the inner cylinder 56. In the present embodiment, the spacer 60 has a cylindrical shape.

The length of the spacer 60 in the central axis O direction is set to be shorter than the length of the inner cylinder 56 in the central axis O direction by a predetermined length. Both ends of the spacer 60 in the central axis O direction can respectively be in contact with a head 58a of the bolt 58 and the nut 59 with the first abutment plate 67 and the second abutment plate 68 interposed therebetween during tightening of the bolt 58 and the nut 59. The spacer 60 can regulate a tightening amount ΔL (see FIG. 4) of the bolt 58 and the nut 59 to the inner cylinder 56 by being in contact with the head 58a of the bolt 58 and the nut 59. Consequently, the spacer 60 can set the pressing force, which is applied to the inner cylinder 56 by the bolt 58 and the nut 59. Here, in the present embodiment, the tightening amount ΔL refers to a distance by which the nut 59 is advanced toward the head 58a of the bolt 58 by further screwing of the nut 59 from a screwing position (see FIG. 4) immediately before the bolt 58 and the nut 59 apply a compressive force to the inner cylinder 56. Note that “L” in the drawing indicates the distance between the head 58a and the nut 59 immediately before the bolt 58 and the nut 59 apply a compressive force to the inner cylinder 56.

Here, the outer diameter of the spacer 60 is set to be slightly smaller than the outer diameter of the inner cylinder 56. The inner diameter of the spacer 60 is set to be slightly larger than the outer diameter of the bolt 58. Consequently, the spacer 60 is replaceable with respect to the inner cylinder 56 (bush body 53). That is, for example, as illustrated in FIG. 3, the spacer 60, which is set to be different in length in the central axis O direction from the inner cylinder 56, can be selectively inserted into the inner cylinder 56.

According to such an embodiment, the anti-vibration bush 50 includes the outer cylinder 55, the inner cylinder 56 provided inside the outer cylinder 55, the rubber 57 provided so as to fill the space between the outer cylinder 55 and the inner cylinder 56, the bulging cylinder 65 provided at the intermediate part of the inner cylinder 56 in the central axis O direction and having a shape bulging radially relative to the inner cylinder 56, the bolt 58 and the nut 59 that apply a compressive force in the central axis O direction to the inner cylinder 56 at the ends of the inner cylinder 56 during the tightening of the inner cylinder 56 and the bracket 40, and the spacer 60 inserted between the inner cylinder 56 and the bolt 58 along the central axis O direction of the inner cylinder. The spacer 60 has the length shorter than the length of the inner cylinder 56 in the central axis O direction, and regulates the compressive force, which is applied to the inner cylinder by the bolt 58 and the nut 59, when the bolt 58 and the nut 59 are brought into contact with the ends of the spacer 60. The bulging cylinder 65 undergoes radially outward deformation in response to a deformation amount corresponding to the pressing force applied to the inner cylinder 56, thus pressing the rubber 57. Consequently, the anti-vibration characteristics of the anti-vibration bush 50 can be efficiently adjusted.

That is, simply preparing in advance the spacers 60 having different lengths and replacing the spacer 60 to be inserted into the inner cylinder 56 enables the adjustment of the deformation amount of the bulging cylinder 65 and the change of the reference elastic properties (stiffness) of the rubber 57. The stiffness of the rubber 57 contributes to the anti-vibration characteristics of the anti-vibration bush 50. Thus, the anti-vibration characteristics of the anti-vibration bush 50 can be efficiently adjusted simply by replacing the spacer 60 having a simple shape.

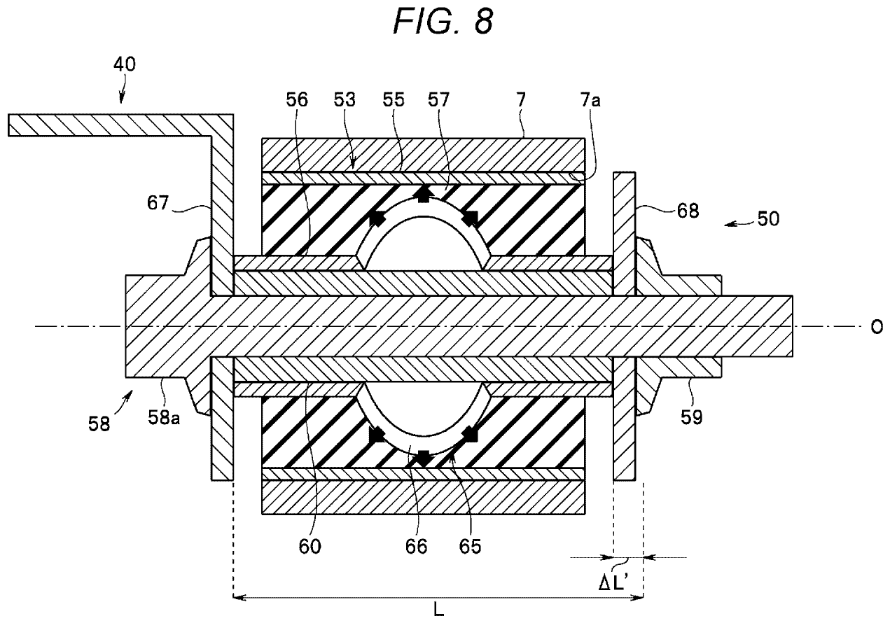

For example, as illustrated in FIG. 8, inserting the spacer 60 shorter than the spacer 60 illustrated in FIG. 4 into the inner cylinder 56 can make a tightening amount ΔL′ of the bolt 58 and the nut 59 larger than the tightening amount ΔL illustrated in FIG. 4. Consequently, the bolt 58 and the nut 59 illustrated in FIG. 8 apply a larger pressing force to the inner cylinder 56 than the bolt 58 and the nut 59 illustrated in FIG. 4, thus greatly deforming the bulging cylinder 65. Accordingly, the bulging cylinder 65 illustrated in FIG. 8 can apply a larger pressing amount to the rubber 57 than the bulging cylinder 65 illustrated in FIG. 4, and the reference stiffness of the rubber 57 can be set high.

In this case, the bulging cylinder 65 has the slits 66 for promoting the radially outward deformation of the bulging cylinder 65. Consequently, the deformation of the bulging cylinder 65 corresponding to the pressing force applied to the inner cylinder 56 can be accurately achieved.

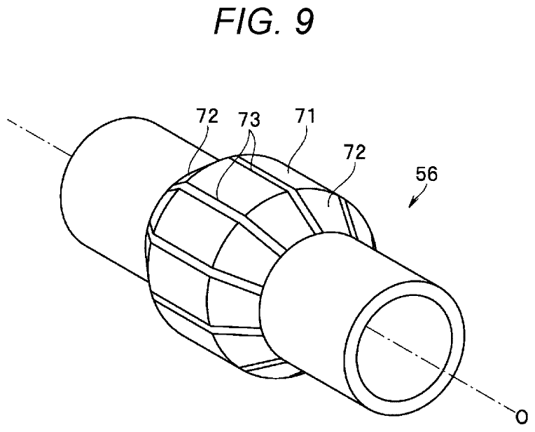

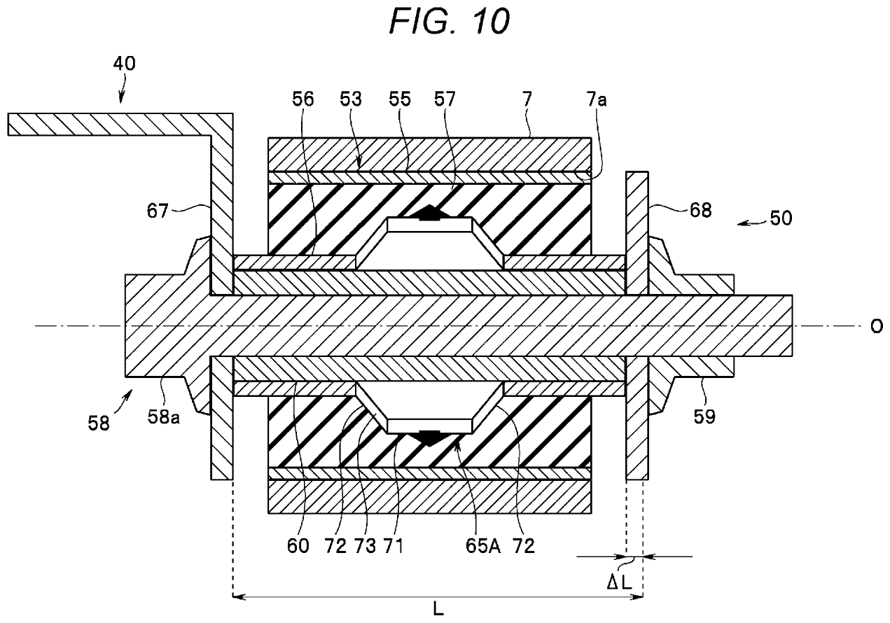

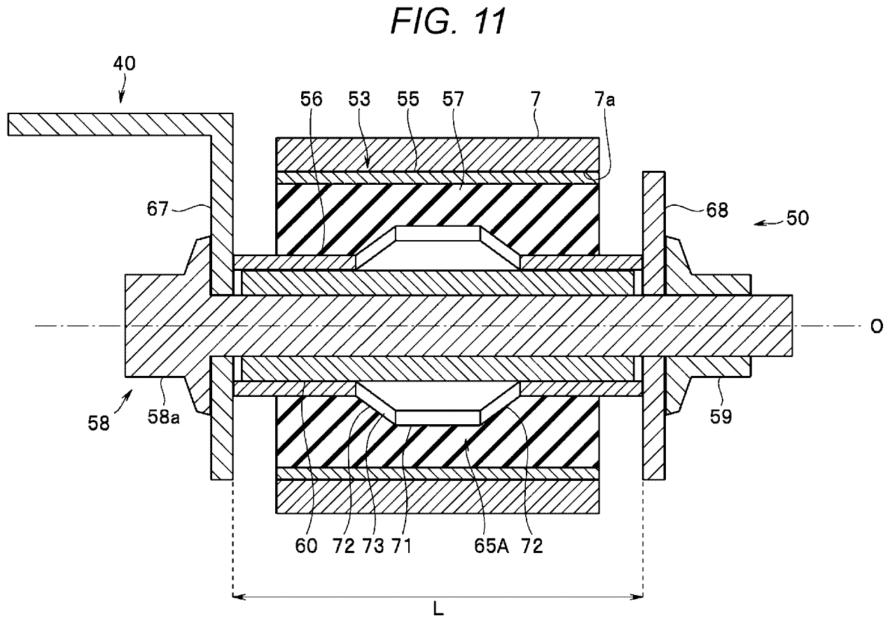

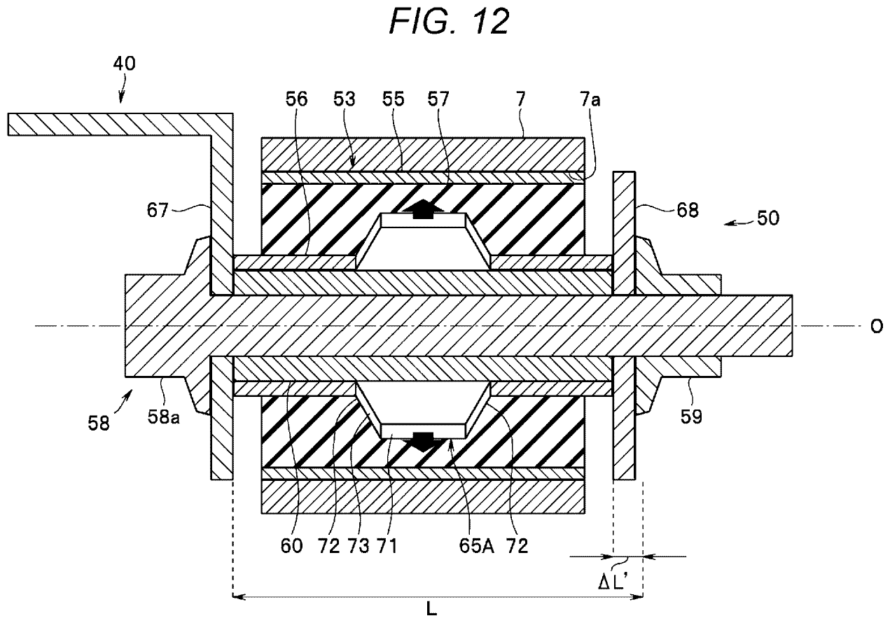

Next, a modification example of the present embodiment will be described with reference to FIGS. 9 to 12. The present modification example is different from the above-described embodiment in a shape of a bulging cylinder 65A.

The bulging cylinder 65A has a cylindrical part 71 and truncated conical cylinder parts 72. The outer diameter of the cylindrical part 71 is set to be larger than the outer diameter of the inner cylinder 56. The truncated conical cylinder parts 72 are provided at both ends of the cylindrical part 71.

Here, the bulging cylinder 65A has slits 73 extending in the central axis O direction of the inner cylinder 56. For example, the slits 73 are provided at equal intervals around the central axis O of the inner cylinder 56. The slits 73 serve as deformation promoting parts for promoting outer-diameter-directional elastic deformation of the bulging cylinder 65A when a compressive force in the central axis O direction is applied to the ends of the inner cylinder 56.

Such a modification example can obtain the advantageous effects similar to those of the above-described embodiment.

The disclosure described in the embodiment is not limited to the embodiment, but various modifications may be made without departing from the scope of the disclosure in the implementation phase.

For example, in the above-described embodiment, the example has been described in which the anti-vibration bush is applied to the suspension apparatus 1, but the application of the anti-vibration bush is not limited thereto. For example, the disclosure can also be applied to a multilink suspension apparatus that uses more anti-vibration bushes. Furthermore, the application of the anti-vibration bush is not limited to the suspension apparatus. The anti-vibration bush can also be applied to, for example, coupling between a mount for mounting an engine, a motor, or the like and a vehicle body frame.

Furthermore, the embodiment includes disclosures at various stages, and the various disclosures can be extracted from the embodiment by appropriately combining disclosed elements.

For example, even if some elements are removed from all the elements indicated in the embodiment, this configuration in which the elements are removed can be extracted as the disclosure as long as the problem described above can be solved and the advantageous effects described above can be obtained.

1. An anti-vibration bush comprising:
an outer cylinder;
an inner cylinder provided inside the outer cylinder;
an elastic body provided so as to fill a space between the outer cylinder and the inner cylinder;
a bulging cylinder provided at an intermediate part of the inner cylinder in a central axis direction and having a shape bulging radially outward relative to the inner cylinder;
a tightening member configured to tighten the inner cylinder and a bracket and apply a compressive force in the central axis direction to the inner cylinder at both ends of the inner cylinder during tightening the inner cylinder and the bracket; and
a spacer configured to be inserted between the inner cylinder and the tightening member along the central axis direction of the inner cylinder, wherein
the spacer has a length shorter than a length of the inner cylinder in the central axis direction, and is configured to regulate the compressive force when the tightening member is brought into contact with both ends of the spacer, and
the bulging cylinder is configured to undergo radially outward deformation in response to a deformation amount corresponding to the compressive force applied to the inner cylinder, and thus press the elastic body.

2. The anti-vibration bush according to claim 1, wherein the bulging cylinder has a deformation promoting part configured to promote the radially outward deformation of the bulging cylinder when the compressive force is applied to the inner cylinder.

3. The anti-vibration bush according to claim 1, wherein the spacer is replaceable with respect to the inner cylinder.

4. The anti-vibration bush according to claim 1, wherein the bulging cylinder has a hollow partially spherical shape.

5. The anti-vibration bush according to claim 1, wherein the bulging cylinder has a cylindrical part and truncated conical cylinder parts provided at both ends of the cylindrical part.
